(19) United States
(12) Patent Application Publication
(10) Pub. No.: US 2003/0018809 A1
(43) Pub. Date: Jan. 23, 2003

(54) Data path selection device

(76) Inventor: Werner Agne, Rothenbach (DE)

Correspondence Address: BAKER & BOTTS, 30 ROCKEFELLER PLAZA, NEW YORK, NY, 10112

(21) Appl. No.: 10/056,878

(22) Filed: Nov. 13, 2001

(30) Foreign Application Priority Data
Jun. 20, 2001 (DE) 101 295 72.3

(51) Int. Cl. G06F 15/173

(52) U.S. Cl. 709/238

(57) ABSTRACT

The invention relates to a data path selection device (DS1-DS6) having at least two data terminals for a line-bound data transmission system. Any desired data path connections (DV) can be set between the data terminals of the data path selection device (DS1-DS6). The data path connections (DV) can be defined via an existing or an additional setting signal input (E), by means of a setting signal. The electrical isolation of data terminals and use of a data connection (D, AB) with a real-time capability, such as a real-time-capable Ethernet connection, are a feature of the invention.

### SPECIFICATION

1. Field of the Invention

The invention relates to a data path selection device having at least two data terminals for a line-bound data transmission system.

2. Background of Invention

In data transmission systems, there are a number of disadvantages which have to be accepted when complex system structures and/or a large number of participants are to be implemented. In particular, in a data transmission system with a real-time capability, the cycle time has to be increased as the number of participants increases, in order to ensure that each participant can be addressed in the cycle. One further possibility is to increase the clock rate if technically possible.

European patent application EP 0 816 963 A1 describes a method of operating a drive system and a device for implementing the method. A drive system having at least two drive groups and a number of drives controlled by drive controllers is supplied via a global synchronization clock. The individual drive groups have local synchronization clocks, which are equalized with the global synchronization clock via the drive controllers. As a result of the comprehensive synchronization of the local synchronization clocks of the drive groups by means of a global synchronization clock, the intention is that there should be no restrictions with respect to the number of drives to be connected. The restrictions are traced back to the cycle times needed with the increasing number of drives in the communication ring, and the associated synchronization errors. In addition, a rotary printing machine is described.

The international application WO 97/11848 describes a rotary printing machine which comprises a number of producing units, referred to as the rotating system and which operate simultaneously and independently of one another. Each producing unit comprises, inter alia, reel carriers for the paper reels, pull rolls for pulling the paper web in and out at the printing towers, printing points, which combined as U, Y, or H-printing units operate in one or more printing towers, and auxiliary drives at the printing points and the folder.

### SUMMARY OF THE INVENTION

The object of the present invention is to make the following possible, in a line-bound data transmission system and/or in a communication subgroup:

To permit the formation of communication participant groups;

To provide a flexible communication-group or communication-subscriber association; and

To construct an optimum number of participants in communication groups.

This objective is achieved by making it possible to set any desired data path connections between the data terminals of the data path selection device, whereby at least one communication participant can be associated with further communication participants.

The data path selection device permits any desired possible connection between the data inputs and outputs. For example, in the case of a data path selection device having two terminals for a data input and a data output, a communication participant (or a communication participant group) can be connected up to or separated from an existing data structure. In the case of data path selection devices having more than two data inputs or outputs, complex data structures can be constructed and associated flexibly. The division of the groups can be constructed on the basis of the communication requirement with other communication participants.

A preferred embodiment of the present invention is where the data path connections can be defined via at least one data connection by means of at least one setting signal. Using a setting signal directed to the data path selection device, the data path connections can thereby be produced. This is advantageous, particularly in the event of a fault in the communication units and the necessity to reconnect communication units. In this case, no new hardware connection has to be drawn. Instead new communication structures can be set up, for example via the data path selection device. It is conceivable to transmit the setting signal via the main data line by which the communication participants also communicate. It is also conceivable for a data path selection device to be supplied with a setting signal via an additional input and thereby separate the data path selection device completely from the communication network. In this case, the data path selection device can continue to be controlled via the additional setting signal input.

Another preferred embodiment of the present invention is where at least two data terminals are electrically isolated from one another. This embodiment avoid balancing currents on account of different electrical potentials of data communication participants.

Yet another preferred embodiment of the present invention is where data connections with a real-time capability are used. By means of these data connections, communication participants can be synchronized with one another. This embodiment is also possible where the data terminals are electrically isolated.

Another preferred embodiment of the present invention involves the use of Ethernet connections with a real-time capability as data connections. By using a real-time-capable Ethernet, a standardized, universally employable bus protocol can be used. The Ethernet provides a high transmission capacity and, at the same time, constitutes a cost-effective alternative to existing complex transmission systems.

A preferred method for producing flexible data connections between communication units combined into groups, with a group comprising at least one communication unit having at least one line-bound information exchange between two groups or at least one group and a control computer, requires the following:

using data connections with a real-time capability between the communication units and/or the communication groups;

using at least one data path selection device to produce the data connection between the groups; and

setting desired data path connections of the data path selection device by means of a configuration.

In accordance with this method, an optimum number of participants per communication group can be set up. Further, the performance of the data exchange between the communication participants can be enhanced. Since the total number of communication participants is divided up into groups, a lower cycle time for the data connection with a real-time capability can be implemented in the groups. In the case of large numbers of participants, it must continue to be ensured that each participant can be reached in a defined, shortest possible time interval. However, the high number of participants leads to a long cycle time. By forming groups of communication participants, the cycle time in the groups can be reduced. Therefore, it is possible to react more quickly to events. When this method is used, for example, in machine tools, production machines or robots, a deviation in a closed-loop or open-loop control program can be compensated for under certain circumstances by means of a shorter cycle time.

Another preferred method of the present invention is where data paths of the data path selection device are set automatically by means of at least one sequence step, depending on the technical requirements. For example, depending on the operating mode, or program sequence or fault, a reaction can be made automatically and in a predefined way. If, for example, a communication branch fails, this data path can be isolated from the main communication stream when the failure is detected. It is also conceivable for a higher-order communication unit to arrange for a plurality of data path selection devices to set up a new communications structure with the aid of a setting signal.

A preferred application of the present invention is in machine tools, production machines or robots (i.e. “machines”). These machines are increasingly incorporated into complex technical processes which require intensive communication. With the use of the device according to the present invention and the corresponding method, all the advantages described above can be realized.

A specifically preferred application of the invention is in a printing machine. In order to be able to react as quickly as possible in the event of a fault in a printing machine, it is necessary to be able to allocate drives and associated communication units flexibly. The method and device according to the present invention make this possible. In particular in the case of relatively large printing machines, high costs can arise during down times. These costs can be reduced or avoided completely by means of the simple and flexible reallocation of printing units and rotating systems.

### BRIEF DESCRIPTION OF THE DRAWINGS

The present invention is described below in greater detail and in connection with the exemplary embodiments illustrated in the drawings and in which:

FIG. 1 shows a data path selection device having three data terminals and a setting signal terminal;

FIG. 2 shows a data path selection device having four data terminals and a setting signal terminal;

FIG. 3 shows a detail of a data transmission system having communication groups, and having an associated data path selection device in each case; and

FIG. 4 shows the basic construction of a printing machine with data path selection devices.

### DETAILED DESCRIPTION OF THE INVENTION

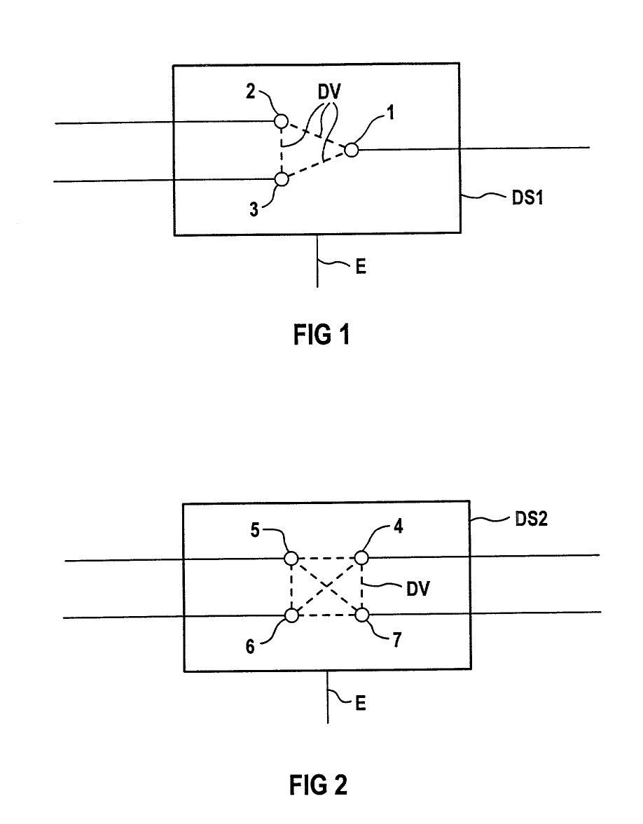

FIG. 1 illustrates a data path selection device DS1 having three data terminals and a setting signal terminal E. The data path selection device DS1 is represented by a rectangle in the interior of which depicts data lines, i.e., the horizontal lines. The respective ends of the data lines 1 to 3 are identified by unfilled circles. Data path connections DV can be produced between these circles 1 to 3. This possibility is shown by dashed lines between the circles 1 to 3. It is thus possible for any desired data line to be connected to at least a further data line. A setting signal input E permits remote setting of data path connections DV with the aid of a setting signal.

The internal production of data path connections DV for the data path selection device DS1 can be carried out in the simplest design via plug-in links, for example, if there is no setting signal input E. Given the possibility of making the data path connections DV by means of a setting signal, all the known possibilities of connecting up signals, such as relays and semiconductor switches, can be implemented.

In FIG. 2, a data path selection device DS2 having four data terminals and a setting signal terminal E is shown. Any desired data path connections DV, which are illustrated by dashed lines, can be produced between the data terminal ends 4 to 7. In this case, it is also possible not only to produce one data path connection DV but also to introduce a plurality of mutually independent data connections DV. For reasons of simplicity, only data path connection DV is shown in FIG. 2.

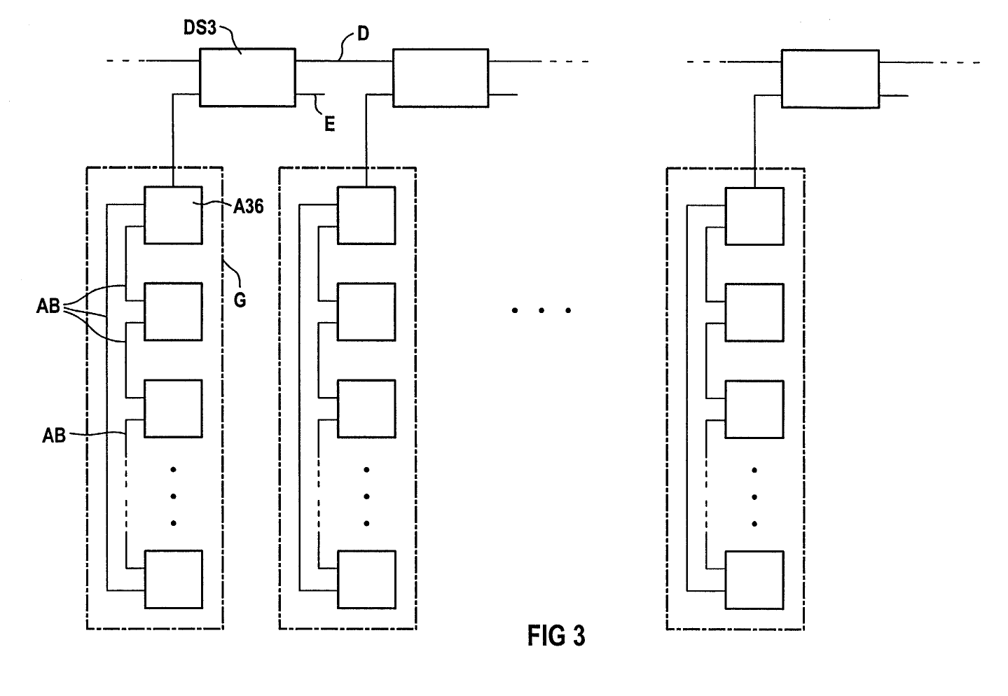

FIG. 3 illustrates a detail from a data transmission system having communication groups G and having an associated data path selection device DS3. A communication group G can comprise a large number of communication participants e.g. up to A36 is shown within the rectangle with a bold dashed border. The communication participants are connected by a communication bus AB, which can be a drive bus, for example.

The data path selection device DS3 is connected to further data path selection devices but which is not shown for reasons of simplicity. The communication groups G go out from this communication stream D. With the aid of a setting signal at a setting signal input E, the communication groups G can be connected to the stream D.

For reasons of simplicity, only the communication participant . . . A36 is depicted in FIG. 3. This may be, for example, a drive controller which is connected to further drive controllers via a drive bus AB, such as a Profibus or an Ethernet with a real-time capability. Within the communication group G, optimization of the number of participants can be performed in order to optimize the performance of the individual drive controllers. As a result of a low number of participants on the drive bus AB, a shorter cycle time can be set, which permits quicker reaction of the individual drive controllers.

In FIG. 3, three dots arranged vertically in each case identify the fact that further communication participants can be added within a communication group G, or additional communication groups G can be added to the stream D by means of a data path selection device e.g. DS3, etc. The communication stream or data connection D can also be designed, as a star or partial star.

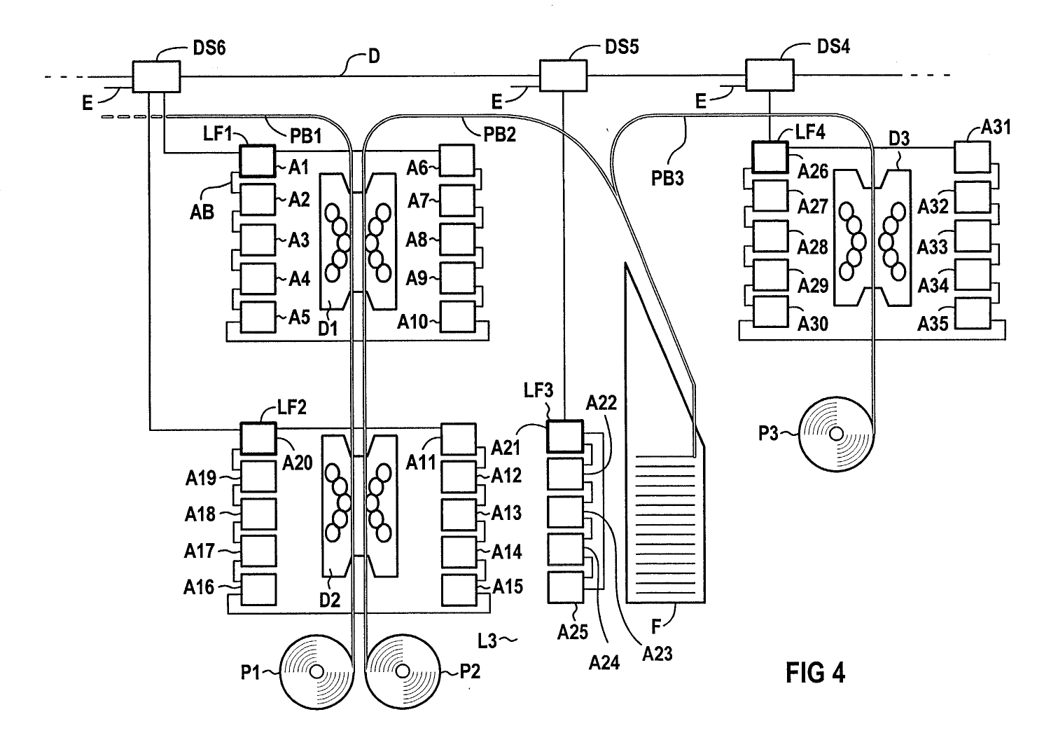

In FIG. 4, the basic construction of a printing machine having data path selection devices DS6, DS5, DS4 - - - is illustrated. From paper reels P1 to P3, paper webs PBS to PBS run through printing units D1 to D3, and also to a folder F. After passing through the printing unit D1, the paper web PBS passes to further processing units, not shown in FIG. 4. As shown in the drawing, the paper web PBS runs out as a dashed line.

A printing unit D1 to D3 is depicted by an approximately H-shaped outer contour. In the printing units D1 to D3 there are in each case ten cylinders, represented by circles, which are arranged in two groups of five cylinders each. All the cylinder-like or wheel-like machine elements in a printing unit D1 to D3, and also in a folder F, are designated by the cylinders. The paper webs PBS to PBS run over these groups, which are designated printing points in the printing units D1 to D3.

A printing point substantially comprises a rubber-covered cylinder, a plate cylinder and an inking and damping unit. With each printing point, one color can be printed on one side of a paper web PBS to PBS. All the printing points, which operate in a folder F, that is to say whose printed paper webs PBS to PBS are led to a folder F, belong to a rotating system. In this case, the printing units D1 to D3 are normally accommodated in printing towers.

Associated with each individually driven cylinder is a drive having a communication unit A1 to A35 which, in this example, is designated drive controller A1 to A35. The drive controllers A1 to A35 of a printing unit D1 to D3, and also the folder F, have a drive controller with a control functionality LF1 to LF4 (master) for each group. Said controller can, for example, predefine set points for the drive controllers belonging to the group. In this case, a group comprises drive controllers A1 to A35 which are networked in a ring and which can also be connected into any further type of network that can be implemented.

The drive controllers A1 to A35 are represented by an open, virtually square rectangle. The drive controller A1 to A35 which has a control functionality LF1 to LF4 is identified by a border drawn more boldly.

The drives or communication units A21 to A25 are associated with the folder F in FIG. 4. The drive A21 has the control functionality LF3 for the drive group associated with the folder F.

There is a data connection D to each drive controller A1 to A35 with a control functionality LF1 to LF4. If, for example because of a defect, the printing unit D3 in FIG. 4 fails, then it can be isolated from the data connection D by means of the data path selection device DS4. For this purpose, a setting signal is supplied to the associated setting signal input E.

In order to continue the printing operation on the folder F, the paper web PB1 can be led to the folder F. By means of the data path selection device DS6, the drive controllers A1 to A10 of the printing unit D1 can also be associated to the folder F in terms of data. For this purpose, appropriate data path connections DV of the data path selection devices DS4 to DS6 are needed. These can be implemented with the aid of setting signals on the data path selection devices.

It is therefore readily possible for the operator of the printing machine to continue his printing operation. Since it is precisely in the case of printing machines that accurate synchronization of drives is important in order to obtain a high-quality printed image, the optimization of participants with an enhancement of performance can be achieved in the respective group by means of the formation of a data group. In this way, the cycle time in the groups can be kept to a minimum, and hence it is possible to react more quickly to control deviations, and thereby achieve a high-quality printed image.

I claim:

1. A data path selection device comprising at least two data terminals for a line-bound data transmission system, wherein any desired data path connections are set between the data terminals of the data path selection device.

2. The data path selection device according to claim 1, wherein the data path connections are defined via at least one data connection by at least one setting signal.

3. The data path selection device according to claim 1 wherein at least two data terminals are electrically isolated from one another.

4. The data path selection device according to claim 2, wherein the data connections have a real-time capability.

5. The data path selection device according to claim 4, wherein the data connections are real-time-capable Ethernet connections.

6. A method for producing flexible data connections between communication units combined into groups, wherein a group comprises at least one communication unit having at least one line-bound information exchange between two groups or at least one group and a control computer, said method comprising using data connections with a real-time capability between the communication units and/or the communication groups, using at least one data path selection device to produce the data connection between the groups, and setting desired data path connections of the data path selection device.

7. The method according to claim 6, wherein data paths of the data path selection device are set automatically by means of at least one sequence step.

8. The method according to claim 6 utilized in a machine tool, production machine or robot.

9. The method according to claim 8, wherein the production machine is a printing machine.
